(19) United States
(12) Patent Application Publication
(10) Pub. No.: US 2025/0254145 A1
(43) Pub. Date: Aug. 7, 2025

(54) DRIVER ASSISTANCE SYSTEM AND VEHICLE

(71) Applicant: Black Sesame Technologies Co., Ltd., Wuhan (CN)

(72) Inventor: Hai Li, Wuhan (CN)

(21) Appl. No.: 19/047,998

(22) Filed: Feb. 7, 2025

(30) Foreign Application Priority Data
Feb. 7, 2024 (CN) 2024101791723

(51) Int. Cl. H04L 9/40

(52) U.S. Cl. CPC H04L 63/02

(57) ABSTRACT

A driver assistance system according to the present disclosure includes: a plurality of devices configured to transmit data or signals; and a chip system including a security processor. The security processor is configured to run a firewall program to build a firewall module embedded into the chip system. The firewall module intercepts the data or signals transmitted by the devices according to a predetermined rule. A firewall of the driver assistance system is embedded into a chip and is a chip-level firewall. The firewall embedded into the chip can be directly integrated with hardware of the driver assistance system to provide more stable and reliable security protection.

### RELATED APPLICATION

This application claims the benefit under 35 U.S.C. § 119(a) of the filing date of Chinese Patent Application No. 2024101791723, filed in the Chinese Patent Office on Feb. 7, 2024. The disclosure of the foregoing application is herein incorporated by reference in its entirety.

### TECHNICAL FIELD

The present disclosure relates to the field of on-board communication security, and in particular, to a driver assistance system and a vehicle.

### BACKGROUND

With the continuous development of a vehicle control technology, a vehicle is generally equipped with a driver assistance system, such as an advanced driver assistance system (ADAS). The driver assistance system may monitor an environment around the vehicle through devices such as a sensor, radar, a camera, and a computer, and provide warning and assisted or automated driving functions according to a situation.

Functions of the driver assistance system are implemented relying on on-board network data transmission. However, there are many security risks in existing on-board network data transmission, such as wireless communication security issues in intelligent networked vehicles, security risks in on-board external interfaces, and possible security risks in on-board application software. A current on-board firewall technology is mainly aimed at software firewalls of external devices, and lacks active defense capabilities against intensive access attacks and hardware chip vulnerability attacks in on-board environments. Therefore, there is a need to build a more secure and efficient firewall for data transmission of the driver assistance system.

### SUMMARY

The present disclosure provides a driver assistance system and a vehicle equipped with the driver assistance system. A firewall of the driver assistance system is embedded into a chip and is a chip-level firewall. The firewall embedded into the chip can be directly integrated with hardware of the driver assistance system to provide more stable and reliable security protection.

In one aspect, the present disclosure provides a driver assistance system, including: a plurality of devices configured to transmit data or signals; and a chip system including a security processor, the security processor being configured to run a firewall program to build a firewall module embedded into the chip system, and the firewall module intercepting the data or signals transmitted by the plurality of devices according to a predetermined rule.

In some embodiments, the chip system further includes an application processor; the application processor being started after the firewall module is built, and being configured to run an application program of the driver assistance system to cause the plurality of devices to transmit the data or signals.

In some embodiments, the driver assistance system further includes a plurality of memory areas respectively used by the plurality of devices when transmitting the data; wherein the security processor is configured to enable or disable access of the application processor to part of the plurality of memory areas of the driver assistance system.

In some embodiments, the security processor includes a plurality of security control registers respectively configured to set firewall modules with different predetermined rules for different devices, the plurality of security control registers being accessible only by the security processor.

In some embodiments, the security processor is integrated with a one time programmable (OTP) memory, the OTP memory storing configuration information of the firewall module in an unmodifiable manner and being accessible only by the security processor.

In some embodiments, startup of the driver assistance system includes a plurality of startup stages, a respective component being started in each of the plurality of startup stages; in each of the plurality of startup stages, the driver assistance system verifies correctness of operation of a component started in a current startup stage and verifies correctness of operation of a component started in a previous startup stage; and in response to determining that both the correctness of operation of the component started in the current startup stage and the correctness of operation of the component started in the previous startup stage pass the verification, a next startup stage is entered until the startup of the driver assistance system is completed.

In some embodiments, the firewall module is further configured to: detect whether a data transmission request signal from one of the plurality of devices is legal; allow, in response to determining that the data transmission request signal is legal, the one of the plurality of devices to send data corresponding to the data transmission request signal; and record, in response to determining that the data transmission request signal is illegal, that the one of the plurality of devices has a transmission anomaly, thereby obtaining a device that is recorded as having the transmission anomaly.

In some embodiments, the firewall module is further configured to: detect data transmission request signals from different devices in the plurality of devices according to predetermined priorities.

In some embodiments, the firewall module is further configured to: encrypt the data sent by the one of the plurality of devices and package the data into a secure data chain in a specific format for transmission; and transmit the secure data chain to an intended recipient in response to determining that the transmitted data is a secure data chain that conforms to the specific format, and intercept the transmitted data and record that the one of the plurality of devices has the transmission anomaly in response to determining that the transmitted data is not a secure data chain that conforms to the specific format.

In some embodiments, the firewall module is further configured to: decrypt the secure data chain to calculate a decryption value when the intended recipient receives the secure data chain; and verify whether the decryption value is abnormal, and record that the one of the plurality of devices has the transmission anomaly in response to determining that the decryption value is abnormal.

In some embodiments, the firewall module is further configured to: reduce a priority of the device that is recorded as having the transmission anomaly or set a communication permission thereof to permanently disabled.

In some embodiments, the driver assistance system further includes a buffer memory area; wherein data is transmitted to one of the plurality of devices that is capable of directly exchanging data with the outside of the driver assistance system, data to be transmitted is stored in the buffer memory area through a data transmission channel, and the one of the plurality of devices that is capable of directly exchanging data with the outside of the driver assistance system reads the data by accessing the buffer memory area; and an access permission of the one of the plurality of devices that is capable of directly exchanging data with the outside of the driver assistance system to the buffer memory area is limited to reading data without modification, and the access permission is only opened after the data transmission channel is disconnected.

In some embodiments, the firewall module is further configured to send a diagnostic signal to the device that is recorded as having the transmission anomaly, and determine a state of the device that is recorded as having the transmission anomaly according to a response signal sent by the device that is recorded as having the transmission anomaly to the firewall module in response to receiving the diagnostic signal.

In some embodiments, the firewall module is further configured to judge, according to the data transmission request signal from the one of the plurality of devices, whether the one of the plurality of devices is a device capable of directly exchanging data with the outside of the driver assistance system; and set a dedicated data communication network for the one of the plurality of devices in response to determining that the judgment is yes.

In some embodiments, the firewall module is further configured to record and analyze a running log of the driver assistance system during transmission of the data or signals.

In another aspect, the present disclosure provides a vehicle, equipped with the driver assistance system described according to the above aspect.

A firewall of the driver assistance system according to the present disclosure is embedded into a chip and is a chip-level firewall. The firewall embedded into the chip can be directly integrated with hardware of the driver assistance system to provide more stable and reliable security protection. The driver assistance system according to the present disclosure uses a chip-level firewall, has characteristics of real-time response, low latency, resistance to hardware-level attacks, and can actively defend against various malicious attacks, which, compared with traditional firewalls, processes data faster, allows a larger amount of data, and can provide a higher level of security protection and provide more reliable security protection for an on-board network environment of the driver assistance system.

### BRIEF DESCRIPTION OF THE DRAWINGS

FIG. 1 is a structural block diagram of a driver assistance system according to embodiments of the present disclosure;

FIG. 2 is a structural block diagram of a driver assistance system according to embodiments of the present disclosure;

FIG. 3 is a schematic block diagram of a security processor configuring a firewall module according to embodiments of the present disclosure;

FIG. 4 is an exemplary flowchart of a startup process of a driver assistance system according to embodiments of the present disclosure;

FIG. 5 is a schematic block diagram of various functions of the firewall module during data transmission according to embodiments of the present disclosure; and

FIG. 6 is a schematic diagram of packaging and encryption of data sent by a device according to embodiments of the present disclosure.

### DETAILED DESCRIPTION

In an existing firewall technology, a solution of a software firewall is generally adopted, which is implemented through software programs running within an operating system of a host and is executed relying on resources such as a processor and a memory of the host. The software firewall is required to capture, parse, and filter network data packets, which all require computing power of the processor of the host. Therefore, performance and throughput of the software firewall may be limited by performance of the processor of the host. In addition, since the software firewall runs on top of the operating system of the host, it may be affected by vulnerabilities or attacks of the operating system, resulting in reduced security.

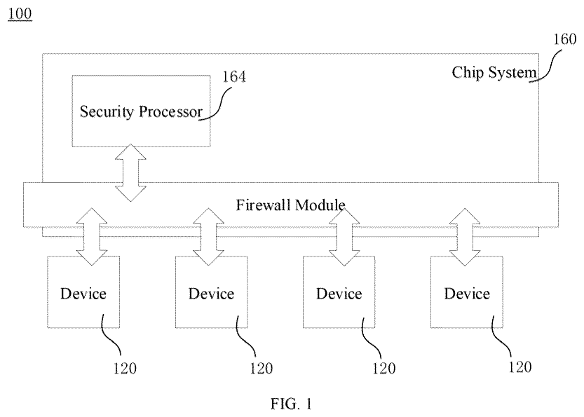

FIG. 1 is a structural block diagram of a driver assistance system according to embodiments of the present disclosure. A driver assistance system 100 includes a plurality of devices 120 and a chip system 160. The plurality of devices 120 includes an internal device and an external device of the driver assistance system. The internal device includes, for example, a sensor, radar, a camera, a computer, and electronic control unit (ECU), and the like. The external device refers to devices in the driver assistance system that can directly exchange data with the outside, including various USB memories, USB interface devices, on-board diagnostics (OBD) interface devices, wireless network connection devices, and the like. The devices 120 are configured to transmit data. For example, the devices inside the driver assistance system such as the sensor, the radar, and the camera may collect data about surroundings of a vehicle and transmit the data to a computer for processing and analysis. The computer may alternatively transmit data with other vehicles, cloud servers, or mobile devices through the wireless network connection devices, such as transmit data such as traffic conditions, road information, and navigation guidance. In addition, interfaces such as USB interfaces and OBD interfaces may alternatively be configured to communicate and exchange data with other devices, such as connect mobile devices through USB interfaces to transmit data files. The plurality of devices 120 are configured to transmit data or signals to implement various functions of the driver assistance system 100. FIG. 1 illustrates 4 devices 120, but it should be understood that the number of the device 120 is not limited thereto.

The chip system 160 includes a security processor 164. In an embodiment, the chip system 160 is a system on a chip (SOC). The chip system 160 integrates modules such as a processor, a memory, an input/output interface, a sensor interface, and other functional modules to implement data processing, control, and communication functions inside the vehicle. In an implementation, the security processor 164 is a Cortex-R5 processor from ARM. The Cortex-R5 processor has higher performance and reliability in data processing and control of on-board electronic systems, can meet stringent real-time requirements, and can assist the on-board electronic systems such as driver assistance systems in implementing efficient and reliable data processing and control functions.

The security processor 164 is configured to run a firewall program. The security processor 164 may be dedicated to processing safety protection-related functions rather than executing functional applications of the driver assistance system. The firewall program may be stored in the memory of the driver assistance system 100, and the security processor 164 runs the firewall program by addressing the memory. By running the firewall program, a firewall module implemented by embedding into the chip system 160 is built. The firewall module implemented by embedding into the chip system 160 means that a firewall function is implemented directly as part of the chip system 160 rather than as an external module or an independent component. This means that at hardware and firmware levels of the chip system, specific circuits, hardware, and logic are used to implement the firewall function to process and control transmission and filtering of the data or signals.

The firewall module according to the present disclosure is also referred to as a safe network-on-chip (safe NOC) firewall. The firewall module is a firewall subsystem operating in an embedded manner in the chip system, such as a hardware circuit capable of realizing a firewall function. NOC is a communication framework built based on chip system. The firewall module according to the present disclosure intercepts, according to a predetermined rule, the data or signals transmitted by the device 120. In the embodiments of the present disclosure, it is illustrated that the firewall module intercepts, according to the predetermined rule, the data or signals transmitted by the device 120. However, it should be understood that the firewall module is also adapted to intercept, according to the predetermined rule, data or signals transmitted by other components or modules in the driver assistance system 100 to the device 120.

In some embodiments, the data or signals transmitted by all the devices 120 in the driver assistance system 100 are required to be detected and filtered by the firewall module. Specifically, the data or signals transmitted by the device 120 are required to be detected and filtered by the firewall module before reaching an intended recipient of the data or signals. When the data or signals transmitted by the device 120 do not conform to the predetermined rule, the firewall module intercepts the data or signals so that the data or signals cannot reach the intended recipient, thereby preventing transmission of illegal data or signals.

The driver assistance system according to the present disclosure uses a chip-level firewall, which is intended to ensure that when the internal device of the driver assistance system encounters random logic faults during use or the external device encounters remote illegal data operations, the firewall module provides security protection to ensure that these random logic faults and illegal data operations may not lead to failure of the entire driver assistance system.

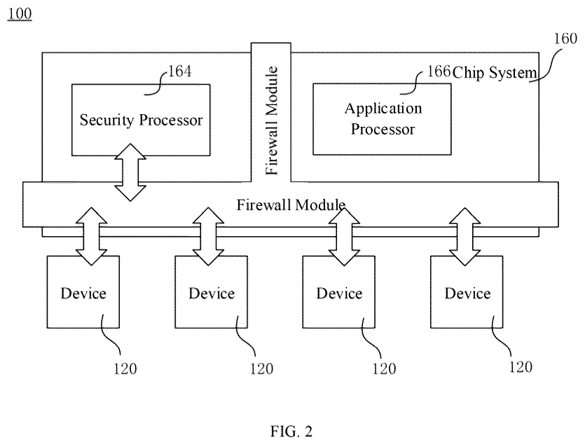

Referring to FIG. 2, in some embodiments, the chip system 160 further includes an application processor 166. The application processor 166 is another processor separated from the security processor 164. In an implementation, the application processor 166 is a Cortex-A55 processor from ARM. The application processor 166 is configured to run an application program of the driver assistance system 100, and is responsible for operation of program middleware and big data calculation and processing, allowing the plurality of devices to transmit data or signals to implement various functions of the driver assistance system 100. That is, the plurality of devices may transmit the data or signals under control of the application processor 166. In a specific example, the application processor is connected to the plurality of devices 120 or connected to different interfaces/modules of the driver assistance system 100 through software of the program middleware, thereby controlling the plurality of devices 120.

The application processor 166 is started after the firewall module is built, to ensure that data or signals generated or processed by the application processor 166 during execution of functional applications are required to be detected and filtered by the firewall module. The firewall module is released and controlled by the security processor 164. That is, the data or signals transmitted by the plurality of devices 120 are controlled by the security processor 164 when passing through the firewall module. It is to be noted that the data or signals transmitted by the application processor 166 may also be detected and filtered by the firewall module. That is, the firewall module is also configured to intercept, according to the predetermined rule, the data or signals transmitted by the application processor.

In some embodiments, the driver assistance system 100 further includes a plurality of memory areas respectively used by the plurality of devices 120 when transmitting the data. The security processor 164 is configured to enable or disable access of the application processor 166 to part of the plurality of memory areas of the driver assistance system 100.

Specifically, the plurality of devices 120 are required to use the memory when transmitting data, different memory areas are dedicated to different devices 120, and the application processor 166 is required to access the memory areas when controlling the plurality of devices 120 to execute functional applications. Generally, an access permission of the application processor 166 to the memory area is controlled by an on-board ECU, to control a traveling state of a car and execute functional applications. In this embodiment, the driver assistance system 100 may include two operating modes: a security system operating mode controlled by the security processor 164 and an application system operating mode controlled by the application processor 166. As an example, in the security system operating mode, only part of the memory areas is accessible to the application processor 166. That is, the firewall module may prevent the application processor 166 from communicating with the memory area protected by the firewall module, thereby preventing the application processor 166 from executing functional applications. Exemplarily, in the security system operating mode, the application processor 166 cannot execute functional applications, and only the security processor 164 can maintain security of the overall system. The security processor 164 builds a firewall module to enable a security service to perform services such as authentication, encryption, firmware upgrades, and the like. In the application system operating mode, the application processor 166 can access all memory areas to execute functional applications. However, in the application system operating mode, the application processor 166 still cannot configure a firewall control register of the security processor 164, thereby eliminating malicious behaviors and abnormal events that tamper with the firewall control register.

In the above example, the chip system 160 is a dual-core design, including the security processor 164 and the application processor 166. The security processor 164 may be dedicated to processing safety protection-related functions rather than executing functional applications of the driver assistance system, so that safety protection and functional applications of the driver assistance system are isolated from each other. This prevents influences of functional application programs and execution processes of the application processor on a security protection program of the security processor.

In some embodiments, the security processor 164 integrates a plurality of security control registers, and the security control registers are only accessible to and modified by the security processor 164. This means that neither the application processor 166 configured to run functional applications of the driver assistance system 100 nor other devices or components in the driver assistance system 100 can access and modify the security control register. The plurality of security control registers are respectively configured to configure firewall modules with different predetermined rules for different devices 120. In other words, the plurality of security control registers are respectively configured to control data transmission configurations for different devices 120. This may also be understood as that the security processor 164 configures different firewall modules for different devices 120. The firewall module may set different levels of interception rules for data or signals transmitted to/from different devices. That is, the predetermined rule may differ between different devices. Values of the security control registers indicate enabling or disabling the corresponding firewall modules and the interception rules of the corresponding firewall modules for data or signals. Since the security processor 164 configures different firewall modules for different devices 120, values of control registers corresponding to different firewall modules are different, and the corresponding predetermined rules for intercepting the data or signals are also different. In some embodiments, splitting granularity of the transmitted data may be set, such as 256K, and split data may be combined and arranged to correspond to the corresponding security control registers.

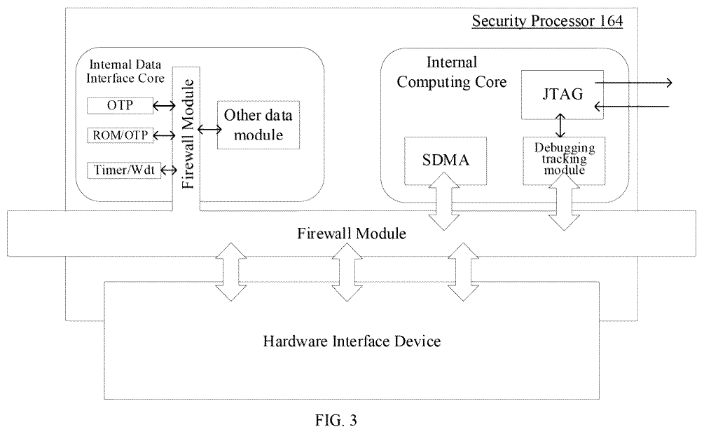

FIG. 3 is a schematic block diagram of the security processor 164 configured with a firewall module according to embodiments of the present disclosure. The security processor 164 includes an internal data interface core and an internal computing core. The security processor 164 may be, for example, a Cortex-R55 processor from ARM, but is not limited thereto. The following explanation takes the security processor 164 as the Cortex-R55 from ARM as an example. An internal data interface is schematically connected to OTP, ROM/OTP, Timer/Wdt, and other data modules.

In some embodiments, the security processor is integrated with an OTP memory. The OTP memory stores configuration information of the firewall module in an unmodifiable manner and is only accessible to and modified by the security processor. That is, neither the application processor 166 configured to run functional applications of the driver assistance system 100 nor other devices or components and modules in the driver assistance system 100 can access and modify the OTP memory. Once the OTP memory is programmed, content data thereof is locked and cannot be modified or deleted. The configuration information of the firewall module includes, for example, intercepted data traffic, a fault state of the firewall module, and a number of rules of the firewall module. Due to a single-time programming characteristic, the OTP memory can provide higher security and reliability and can protect data from unauthorized access or tampering.

The ROM/OTP refers to a read-only memory and a one time programmable memory, which is configured to store settings of security registers and ID information of the plurality of devices in the driver assistance system, and is configured to detect data transmission requests (such as data interrupt requests, which will be described later) from the plurality of devices. In an example, sizes of the ROM and the OTP are both 4 MB.

The Timer/Wdt refers to a watchdog timer, which is a timer configured to monitor an operating state of the system. It may periodically receive a specific signal or counter to reset and keep the timer active during normal operation of the system. If a system fault or an anomaly prevents timely resetting of the WDT, the timer times out and triggers a reset or another specified action. In the embodiment, a data communication anomaly may cause program deadlock in an intelligent assisted driving system. The Timer/Wdt ensures that the system can exit in time in the event of the data communication anomaly, that is, exit this deadlock state. The Timer/wdt can interrupt the intelligent assisted driving system through an interrupt program to force the intelligent assisted driving system out of this deadlock state.

In practical applications, the internal data interface core is also connected to other data modules, for example, a random number generator (RNG), an advanced encryption standard (AES), a public key accelerator (PKA), a cyclic redundancy check (CRC) and security algorithm module (such as SHA2, SM2/3/4), and the like. Those skilled in the art can learn specific functions and meanings of the above modules by referring to processor documents.

The internal computing core schematically includes a joint test action group (JTAG) connector, synchronous direct memory access (SDMA), a debugging tracking module, and the like.

The JTAG connector supports real-time tracking and debugging, with a purpose of analyzing and backing up a log (LOGO, which will be described in detail later) of operation of channel data of the firewall module.

The SDMA represents synchronous direct memory access. The SDMA allows peripherals (such as a network adapter, an audio codec, and an image processor) to directly access the memory of the system without intervention by a CPU, thereby achieving efficient data transmission.

The debugging tracking module is, for example, a CoreSight framework, which includes a set of hardware modules specifically designed to support debugging, tracking, analyzing, and optimizing applications. The modules include a debugger interface, a trace interface, an embedded clock, a flip-flop, and the like. Through these modules, developers can debug, perform performance analysis on, and optimize running application programs.

As shown in FIG. 3, the firewall module isolates the security processor 164 in the upper half from a hardware interface device in the lower half, and is a chip-level firewall system. The hardware interface device includes, for example, an advanced peripheral bus (APB) as an I/O interface of the security processor 164, a general interrupt controller (GIC), a static random access memory (SRAM), a quad serial peripheral interface flash (QSPI Flash), and the like.

It should be understood that the security processor 164 may be dedicated to processing safety protection-related functions rather than executing functional applications of the driver assistance system. Therefore, only data or signals related to security protection are required to reach the security processor 164, such as key data for encryption and decryption and interrupt signals as data transmission request signals (both will be described in detail later). Exemplarily, stricter interception rules are set for data or signals whose intended recipient is the security processor 164 (i.e., data or signals that are to enter the security processor 164) than for data or signals whose intended recipient is another device or component, to ensure operational safety of the security processor 164.

In the embodiment, the hardware interface device in the lower half part of the figure must be based on a security protection data chain communication rule to initiate a data transmission request signal to the security processor 164. The firewall module may intercept illegal data intrusions and prevent abnormal interruption signals and illegal communication data from entering security areas required to be protected by a core system. In the case of legal communication data and normal interruption signals, if a data chain rule can be met and an initiator initiating the communication data and the interrupt signals is in a whitelist, the firewall module should release the corresponding legal communication data and normal interrupt signals to ensure that the legal communication data and the normal interrupt signals can reach the security processor 164.

In some embodiments, the plurality of devices 120 in the driver assistance system 100 may include a plurality of categories of devices, which may be classified into, for example, a low-speed device and a high-speed device according to requirements for data transmission rates. The low-speed device and the high-speed device are respectively connected to the security processor 164 and the application processor 166 through a low-speed peripheral (LSP) module and a high-speed peripheral (HSP) module respectively. The driver assistance system may include a plurality of LSP modules, for example, LSP0 and LSP1. The LSP modules generally include hardware and an associated driver. The hardware is responsible for a physical connection to the peripherals and providing appropriate electrical interfaces and signal processing. The driver is responsible for interacting with the processor so that the processor can identify and control the connected peripherals. Through the LSP modules, the processor can exchange data and communicate with a low-speed peripheral.

In some examples, the security processor 164 and the application processor 166 communicate with the plurality of devices 120 of the driver assistance system 100 by using LSP1 and LSP0 respectively. To prevent the application processor 166 from accessing LSP1, the security processor 164 should enable the firewall module for LSP1, and the firewall module for LSP0 should also remain enabled.

In some examples, startup of the driver assistance system 100 includes a plurality of startup stages, and a respective component is started in each of the startup stages. In each startup stage, the driver assistance system 100 verifies correctness of operation of the component started in a current startup stage and verifies correctness of operation of the component started in a previous startup stage. When both the correctness of the operation of the component started in the current startup stage and the correctness of operation of the component started in the previous startup stage pass the verification, next startup stage is entered until the startup of the driver assistance system is completed. In some examples, a respective component of a plurality of components is started in each of the plurality of startup stages and the plurality of components are different components.

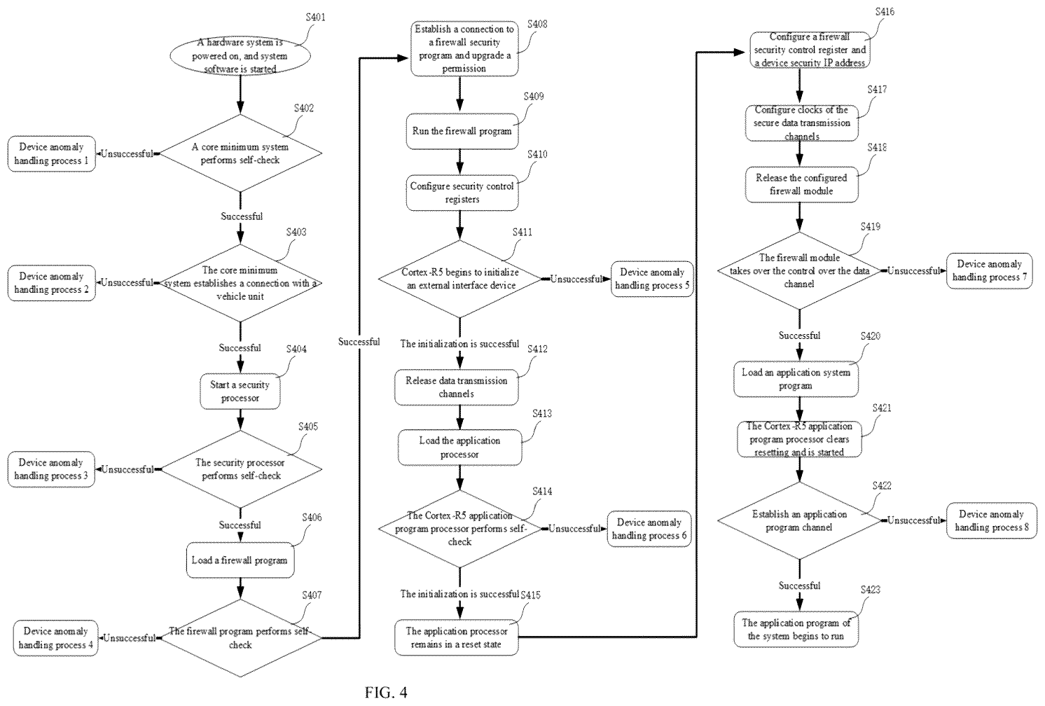

FIG. 4 is an exemplary flowchart of a startup process of the driver assistance system 100 according to embodiments of the present disclosure.

In S401, firstly, when a car is started, a hardware system obtains a start signal and begins to power on, and system software is started. S402 is continued to be performed.

In S402, an SOC core minimum system of the driver assistance system 100 performs self-check. The SOC core minimum system includes an SOC processor. An internal memory of the SOC processor, an external memory of the system, and an external program of the system perform power-on self-check. If the self-check is successful, S403 is continued to be performed. If the self-check is unsuccessful, a device anomaly handling process 1 may be performed. The anomaly handling process 1 herein may find out the reason why the self-check of the SOC processor is unsuccessful and record the reason.

In S403, the SOC core minimum system of the driver assistance system 100 establishes a connection with a vehicle unit. If the connection is successful, S404 is continued to be performed. If the connection is unsuccessful, a device anomaly handling process 2 is performed, and the reason for the unsuccessful connection is founded out and recorded.

In S404, the SOC core minimum system begins to start the security processor 164.

In S405, the security processor 164 may also perform self-check after startup, to ensure the security processor 164 for error checking and correction (ECC) to improve reliability and address security-critical procedures. The self-check in step S404 also includes verifying and confirming the connection in step S403 above and verifying whether an obtained parameter signature is compliant. If the self-check is successful, S405 is continued to be performed. If the self-check is unsuccessful, a device anomaly handling process 3 is performed, and the reason why self-check of the security processor 164 is unsuccessful is found out and recorded.

Verifying the parameter signature means verifying whether all necessary parameter information of an access interface is a normal call request for legal access, for example, verifying whether a random string and a timestamp are consistent within a short period of time. If the parameter signature is compliant, the verification passes and service request information is returned normally. If the parameter signature is not compliant, the verification fails, which proves that the parameter information has been tampered with, the system may be attacked, and an error may be returned.

In S406, the driver assistance system loads a firewall program from an external flash memory.

In S407, the firewall program may also perform self-check to confirm successful startup of the firewall program. The self-check in step S406 also includes verifying and confirming the self-check of the security processor in S405 and verifying whether an obtained parameter signature is compliant. If the self-check is successful, S408 is continued to be performed. If the self-check is unsuccessful, a device anomaly handling process 4 is performed, and the reason why the self-check is unsuccessful is found out and recorded.

In S408, the security processor 164 establishes a connection to the firewall program and upgrades a permission so that the security processor 164 can fully control the firewall program.

In S409, the security processor 164 begins to run the firewall program.

In S410, the security processor 164 begins to configure each of the security control registers.

In S411, the security processor 164 begins to initialize an external interface device and configure related registers. The initialization in step S411 also includes verifying and confirming the operation and configuration of the firewall program by the security processor 164 in S408 to S410, and verifying whether the obtained parameter signature is compliant. If the initialization is successful, S412 is continued to be performed. If the initialization is unsuccessful, a device anomaly handling process 5 is performed, and the reason for the unsuccessful connection is found out and recorded.

In S412, the security processor 164 releases various secure data transmission channels.

In S413, the security processor 164 begins to load the application processor 166.

In S414, the application processor 166 performs self-check. If the self-check is successful, next step is continued to be performed. If the self-check is unsuccessful, a device anomaly handling process 6 is performed, and the reason why the self-check is unsuccessful is found out and recorded. It is to be noted that after the self-check is successful, the application processor 166 may temporarily remain in a reset state (S415), that is, it does not start temporarily and waits until a firewall module is completely built.

In S416, the security processor 164 configures a firewall security control register and a device security IP address.

In S417, the security processor 164 configures clocks of the secure data transmission channels.

In S418, the security processor 164 configures and releases the firewall module.

In S419, the firewall module takes over the control over the data channel. If the control is successful, step S420 is continued to be performed. If the control is unsuccessful, a device anomaly handling process 7 is performed, and the reason why the control is unsuccessful is found out and recorded. In this case, the overall security firewall of the driver assistance system has taken effect and has begun to protect safe operation of the entire system.

In S420, the application processor 166 loads an application system program from the external flash memory.

In S421, the application processor 166 clears resetting and is started.

In S422, the application processor 166 establishes an application program channel. If the establishment is successful, step S423 is continued to be performed. If the establishment is unsuccessful, a device anomaly handling process 8 is performed, and the reason why the self-check is unsuccessful is found out and recorded.

In S423, the application program of the driver assistance system begins to run, and the firewall module controls and monitors data transmission of the device 120 in real time.

Safety of the driver assistance system relies heavily on integrity of the software running on the device. During the startup of the driver assistance system, there is a self-check process in each startup stage. The self-check process is required to verify correctness of operation of the component started in a current startup stage, and is also required to automatically verify parameter signatures of the component started in a previous startup stage. That is, during the startup, each time a component is started, the parameter signatures of the component started in the current startup stage and the component started in the previous startup stage may be verified. After the verification is passed, next startup stage may be continued until the startup of the driver assistance system is completed. In this way, it is ensured that parameter of the component started in the previous startup stage has not been tampered with or corrupted. In this way, unauthorized modification or tampering of the driver assistance system is prevented. This helps to improve safety and reliability of the driver assistance system.

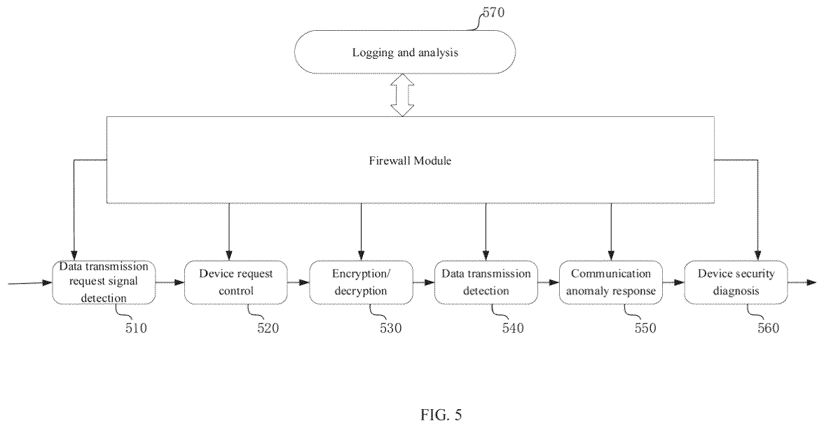

FIG. 5 is a schematic block diagram of various functions of the firewall module during data transmission according to embodiments of the present disclosure. Exemplarily, various functions of the firewall module involved in the data transmission process include: a data transmission request signal detection function 510, a device request control function 520, an encryption/decryption function 530, a data transmission detection function 540, a communication anomaly response function 550, a device security diagnosis function 560, and a logging and analysis function 570.

In some embodiments, for the data transmission request signal detection function 510, the firewall module is further configured to: detect whether a data transmission request signal from the device is legal; allow, when the data transmission request is legal, the device to send data corresponding to the data transmission request signal; and record, when the data transmission request is illegal, that the device has a transmission anomaly.

When the device 120 of the driver assistance system 100 has a data transmission requirement, the device 120 may directly send a data transmission request signal (for example, a data interrupt request signal). It is to be noted that when the device 120 of the driver assistance system 100 has an access requirement for data of the driver assistance system 100, it may also mean that the device has a data transmission requirement. Therefore, access to the data of the driver assistance system 100 also requires sending a corresponding access request instruction. The access request instruction may also be understood as data to be sent by the device 120.

The data transmission request signal may be sent from any device 120 in the plurality of devices 120 in the driver assistance system 10, which may be, for example, a data transmission request signal sent by an on-board internal sensor or a data transmission request signal sent by an on-board USB interface. The data transmission request signal from any device 120 has a corresponding firewall module corresponding thereto, the firewall module identifies and monitors the data transmission request signals to ensure that only the data transmission request signals allowed by the firewall module are responded to, and those possible data transmission request signals that are not allowed are blocked, to prevent serious influences of the data transmission request signals that are not allowed on resources and stability of the driver assistance system. In other words, only legal interrupt request signals that can pass the detection of the firewall module can enter the security processor 164 and be processed by the security processor 164.

In a specific example, after responding to the data transmission request signal from the device 120, the firewall module verifies and controls the device 120 that generates the data transmission request signal. The firewall module first checks whether a device ID of the device 120 corresponds to an ID preset in a device register list. If yes, the firewall module judges that the device 120 is a registered device, and then allows the device 120 to send data corresponding to the data transmission request signal. If not, the firewall module judges that the device 120 is an illegal device, the firewall module may invalidate the data transmission request signal of the device and record that the device from which the data transmission request signal has sent has a transmission anomaly.

In some embodiments, the firewall module is further configured to: detect data transmission request signals from different devices 120 in the plurality of devices 120 according to predetermined priorities.

The data transmission request signal from the device 120 may be saved in a data transmission request signal sequence list of the firewall module. The firewall module saves these data transmission request signals in a sequence list according to preset priorities. The firewall module responds to the data transmission request signals from the devices 120 in order of preset priorities from high to low, thereby detecting the data transmission request signals from different devices 120 in the plurality of devices 120 according to the preset priorities.

For example, in the data transmission request signal sequence list, priorities for different devices are preset according to the devices. For example, in the driving assistance system, internal devices such as various sensor devices and ECU devices have higher priorities, while external devices such as various USB memories, OBD interface devices, and wireless network connection devices have lower priorities.

Therefore, the firewall module builds a device access control mechanism, and only authorized devices 120 or secure endpoints can acquire and modify data stored in the corresponding memory or perform data transmission. The firewall module can ensure security of the entire driver assistance system and can also serve as a security management assembly for data communication.

For the device request control function 520, when the firewall module detects that the data transmission request signal from the device is legal, the device 120 is allowed to perform data transmission.

For the encryption/decryption function 530, in some embodiments, the firewall module is further configured to: encrypt the data sent by the device 120 and package the data into a secure data chain 600 in a specific format for transmission; and transmit the secure data chain to an intended recipient when the transmitted data is a secure data chain that conforms to the specific format, and intercept the transmitted data and record that the device has the transmission anomaly when the transmitted data is not a secure data chain that conforms to the specific format.

In specific implementation, the firewall module calculates different keys according to different devices, more specifically, public and private keys in pairs. The two keys are required to be used together. The public key is stored in a key register and is in a semi-public state and is accessible to any pre-registered device. An accessed device ID number is required to be queried for in the device register list, so that some illegal accesses can also be identified, because the device ID number is assigned by the firewall module and is unique and unchanged. Any attempt to disguise the device ID number thereof may be detected.

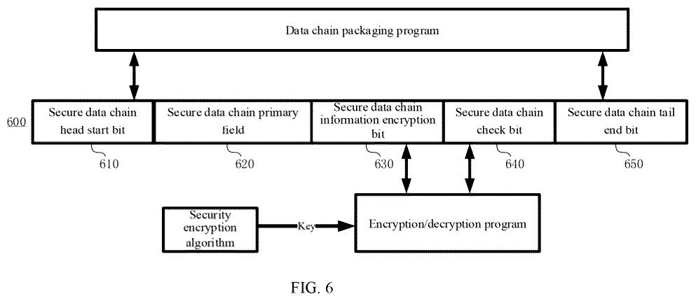

Refer to FIG. 6 together which is a schematic diagram of packaging and encryption of data sent by a device according to embodiments of the present disclosure. When the device sends the data, a secure data chain primary field 620 is generated. In this case, the firewall module calls a data chain packaging program to automatically add a secure data chain head start bit 610 and a secure data chain tail end bit 650 to the data chain primary field. Preferably, the secure data chain head start bit 610 includes a timestamp and a counter verification code, making it easier to identify during subsequent decryption whether the data is transmitted securely. Then, the firewall module uses a secure encryption algorithm to generate a public key and a private key, transmits the public key to a separate encryption/decryption program, and controls the encryption/decryption program to use the public key to encrypt data chain information, thereby generating a secure data chain information encryption bit 630 and a secure data chain check bit 640. Next, the firewall module uses the data chain packaging program to package the secure data chain head start bit 610, the secure data chain primary field 620, the secure data chain information encryption bit 630, the secure data chain check bit 640, and the secure data chain tail end bit 650 into a complete secure data chain 600 that conforms to a specific format, and transmits the complete secure data chain 600 back to the device 120 from which the data is to be sent, for subsequent transmission.

The data to be sent is encrypted by using the secure encryption algorithm, specifically by using an asymmetric encryption method, to prevent eavesdropping and theft of the transmitted data by an unauthorized third party. The first important feature of data encryption is that a same key cannot be used for different functions, for different internal devices, and for different external devices, the same key shall not be used for a long time, and a key type and manner are required to be updated and changed in a timely manner. Communication data authentication, private key exchange, and communication data encryption all require different random non-timed keys. In this way, even if the key used to encrypt certain communication data is leaked, the keys used for other information are not affected. Existing encryption keys can be replaced to distribute new keys. Moreover, the encryption manner is also judged according to an actual situation and replaced regularly or irregularly.

Next, for the data transmission detection function 540, the device 120 from which the data is to be sent sends the secure data chain 600 to the intended recipient. However, it is to be noted that when the device sends the data to the intended recipient, the firewall is required to detect and filter the data. In the example, the firewall transmits the secure data chain conforming to the specific format above to the intended recipient. For example, if the secure data chain encounters illegal tampering during transmission, the secure data chain may no longer have the above specific format and can be easily identified and intercepted by the firewall, and the firewall module records that the device sending the data that is not the secure data chain conforming to the specific format has a transmission anomaly. Exemplarily, the intended recipient in the present disclosure is identified in the data or signal sent, and the intended recipient may be another device 120, the security processor 164, the application processor 166, or other components or modules of the driver assistance system 100.

After being packaged into a secure data chain, data to be transmitted is transmitted in the form of the secure data chain. During the transmission of the secure data chain, in the case of illegal interference or tampering, the specific format of the secure data chain may be destroyed, and the firewall module can intercept the data that has been illegally interfered with or tampered with during the transmission by detecting whether the data sent by the device conforms to the specific format of the secure data chain, so that the data cannot reach the intended recipient of the data.

The data to be transmitted is packaged into a secure data chain through the data chain packaging program, so that the transmitted data has an anti-interference structure and ensures an overall security effect. In addition, in this way, the processed and packaged secure encrypted data chain can be restored to correct data through its own various secure data chain information encryption bit and secure data chain check bit, even if it is subject to signal interference or illegal attacks during the transmission.

In some embodiments, the firewall module is further configured to: decrypt the secure data chain to calculate a decryption value when the intended recipient receives the secure data chain; and verify whether the decryption value is abnormal, and record that the device has the transmission anomaly when the decryption value is abnormal.

Specifically, the firewall module transmits the calculated private key paired with the public key used to encrypt the secure data chain to the encryption/decryption program, controls the encryption/decryption program to use the private key to decrypt the secure data chain, calculates the decryption value, and extracts the secure data chain primary field 620 and the secure data chain check bit 640. The firewall module compares whether the calculated decryption value is equal to the value of the secure data chain check bit 640. If the calculated decryption value is equal to the value of the secure data chain check bit 640, the data may be judged as correct communication data, and the intended recipient uses the decrypted data normally. If the calculated decryption value is not equal to the value of the secure data chain check bit 640, the firewall module may think that a data chain reaching the intended recipient is a damaged data chain, record this situation as a transmission anomaly, record the transmission anomaly of the device transmitting the damaged data chain, and enter an abnormal program state at the same time. In some examples, the firewall module may also detect whether the timestamp and the counter verification code in the chain head start bit obtained by decrypting the secure data chain are valid, and if yes, may also enter the abnormal program state. For the abnormal program state, in some cases, the communication data may be considered as illegal data and discarded, and the device sending the data may also have a reduced priority. In some other cases, the intended recipient may continue to use the data by denoising the data.

For the communication anomaly response function 550, in some embodiments, the firewall module is further configured to: reduce a priority of the device that is recorded as having the transmission anomaly or set a communication permission thereof to permanently disabled.

Firstly, when detecting that the data transmission request signal from the device is illegal, the firewall module reduces the priority of the device sending the illegal data transmission request signal or sets the communication permission of the device sending the illegal transmission request signal to permanently disabled.

The firewall module focuses on identifying an illegal data transmission request signal from an external device. For example, when detecting that an illegal data transmission request signal is sent from an external device, the firewall module immediately updates an identification label of the external device, reduces a priority thereof, or directly disables a communication permission thereof. In this way, a non-secure external device port can be permanently disabled to plug loopholes in the system data channel, the device ID and the priority of the device sending the illegal data transmission request signal are saved in the device register list to facilitate reading and confirmation by other devices, and the device is marked, so that a data transmission request signal from the device is no longer responded to within a period of time, to prevent repeated saturation data attacks.

Secondly, when detecting that the transmitted data is not a secure data chain that conforms to the specific format, the firewall module reduces the priority of the device sending the data that is not the secure data chain conforming to the specific format or sets the communication permission of the device sending the data that is not the secure data chain conforming to the specific format to permanently disabled.

Thirdly, when detecting that the decryption value is abnormal, the firewall module reduces the priority of the device transmitting the corresponding secure data chain or sets the communication permission of the device transmitting the corresponding secure data chain to permanently disabled.

Illegal interception, recording, or control of data by the unauthorized third party can seriously undermine confidentiality of communication data. Whether the communication data has been recorded before and then re-transmitted or whether it has been changed by illegal intermediate devices during the transmission, these illegal operations may not be occurred again, because the corresponding channel of the device has been marked and is focused on by the firewall module.

In some embodiments, the driver assistance system further includes a buffer memory area. When data is transmitted to the device 120 that is capable of directly exchanging data with the outside of the driver assistance system 100, data to be transmitted is stored in the buffer memory area through a data transmission channel, the device 120 that is capable of directly exchanging data with the outside of the driver assistance system 100 reads the data by accessing the buffer memory area. An access permission of the device 120 that is capable of directly exchanging data with the outside of the driver assistance system 100 to the buffer memory area is limited to reading data without modification, and the access permission is only opened after the data transmission channel is disconnected.

In a specific example, the buffer memory area is a separate data area, such as a BUFFER structure. As described above, the device 120 that is capable of directly exchanging data with the outside of the driver assistance system 100 is an external device in the driver assistance system 100, such as a USB interface device or a wireless network connection device. In a specific example, for example, when the internal device (such as the camera sensor) of the driver assistance system 100 is required to transmit data to the external device (such as the wireless network connection device), the data to be transmitted is first stored in this buffer memory area from the camera sensor, the data transmission channel from the camera sensor to the buffer memory area is disconnected, and then an access permission of the wireless network connection device to this buffer memory area is opened. In this way, access from the outside of the driver assistance system 100 can only directly read some relevant data from this separate data area.

The data in the buffer memory area can only be read by the external device (such as the wireless network connection device) and cannot be modified by an external device from a client on an external network of the driver assistance system 100. This is because the buffer memory area is only suitable for storing data through a specified internal port (for example, storing data from the camera sensor), and the data stored in the buffer memory area is not suitable for transmission to the outside of the driver assistance system 100 through the external device of the driver assistance system 100. The data in the buffer memory area is read from the client on the external network of the driver assistance system 100 by specifying an address of the buffer memory area. That is, the data in this buffer memory area may not actually be accessed directly from the outside.

When the client on the external network is connected to the address of the firewall module, it does not mean that the data in the buffer memory area may actually be accessed directly from the outside. The firewall module may compare and detect a destination address of an incoming external access with the address or alias of the firewall module when passing through an internal interface. Such data chain data may not actually pass through an external interface, and the firewall module may not establish such a channel under any circumstance. Therefore, the firewall module may never see that data information on the external access, and a filtering rule may not take effect because the external interface is specified. No other data can be accessed arbitrarily, thereby ensuring functional safety of the entire driving system.

For the device security diagnosis function 560, in some embodiments, the firewall module is further configured to send a diagnostic signal to the plurality of devices 120, and determine states of the plurality of devices according to a response signal sent by the plurality of devices 120 to the firewall module in response to receiving the diagnostic signal. The diagnostic signal is sent to the device that is recorded as having the transmission anomaly in the plurality of devices more frequently than to the remaining devices of the plurality of devices.

Exemplarily, the firewall module may send the diagnostic signal to each device 120 of the plurality of devices 120 to diagnose a data communication state of each device 120. The firewall module can quickly determine whether each device 120 is currently in a safe and normal connection state by storing the data communication state of each device 120 in a device state detection table. For example, the data communication state of the device 120 may include “device data state maintenance” and “device data state detection”. The “device data state maintenance” indicates that the device is currently in a safe and normal connection state, and the “device data state detection” indicates that the device is currently in an abnormal state and is required to be repaired.

The diagnostic signal may be, for example, a heartbeat signal, that is, a periodic signal sent by the firewall module, to detect whether the device operates normally. The diagnostic signal may be a simple data packet or command that the firewall module periodically sends to the device where an abnormal problem occurs, which may be used to verify whether each device 120 is in a normal operating state, to prevent failure of the device.

The diagnostic signal is generally included in corresponding attribute data. The attribute data generally includes state signals of whether the device is on or off and of whether the device alarms or not, and corresponding values thereof, such as an alarm state indicating excessively low data security and an alarm state indicating an error in data chain decryption.

In some examples, when performing device security diagnosis, the firewall module sets an upper limit for a number of communication request attempts for each device 120 according to a specific diagnosis specification definition. For example, for some devices, the number of communication request attempts is set to no more than 3, and when the data or signals sent by the device to the firewall module have a transmission anomaly three consecutive times, the firewall module disables the communication permission thereof.

Preferably, the diagnostic signal is sent to the device that is not recorded as having the transmission anomaly more frequently than to the device that is recorded as having the transmission anomaly. In this way, it is easier to monitor the device that is recorded as having the transmission anomaly, thereby discovering problems in the driver assistance system 100 in a timely manner. As can be seen from the above, transmission anomalies are various abnormal problems detected by the firewall module during monitoring of data or signal transmission, which may be, for example, a situation in which the firewall module intercepts the transmitted data or signals or a situation in which the intended recipient enters an abnormal program state when the decryption value is inconsistent with the value of the check bit.

In some examples, the firewall module further diagnoses corresponding parameters of the device through the diagnostic signal, such as a temperature, pressure, humidity, and vibration of the device, thereby preventing the device from possible problems such as an excessive temperature, excessive pressure, excessive humidity, and excessive vibration.

In some examples, the firewall module further diagnoses, through the diagnostic signal, whether the device has a circuit or connection problem that cannot be identified by a test program, or diagnoses whether other modules or systems associated with the device do not achieve expected performance or function as they should.

In some embodiments, the firewall module is further configured to judge, according to the data transmission request signal from the device 120, whether the device 120 is a device capable of directly exchanging data with the outside of the driver assistance system 100; and set a dedicated data communication network for the device 120 when the judgment is yes.

For example, the firewall module identifies the device ID according to the data transmission request signal, judges which device the data transmission request signal is from, and judges according to the device ID whether the device belongs to an external device that can be connected to the driver assistance system 100. Exemplarily, when the on-board wireless communication device as a device of the driver assistance system sends a data transmission request signal to the firewall module, the firewall module may identify and judge that the on-board wireless communication module belongs to an information device that may be connected to the outside of the driver assistance system, which has great security risks and belongs to a low-priority data transmission request signal. The firewall module controls an underlying communication gateway to open a dedicated data communication network. In this way, the dedicated data communication network is set up for the external device in the plurality of devices 120 of the driver assistance system 100 that can directly exchange data with the outside of the driver assistance system 100, thereby completely separating the wireless communication network from an internal data network. The transmission of the two types of data uses different data communication networks to perform software isolation of the data communication network to diagnose and protect such devices.

For the logging and analysis function 570, in some embodiments, the firewall module is further configured to record and analyze a running log of the driver assistance system 100 during transmission of the data or signals.

The firewall module records and analyzes a running log (LOGO) of the driver assistance system 100 during transmission of the data or signals. For various abnormal problems, the firewall module may save and analyze the running log of the system during the data or signal transmission, to confirm a type of the transmission anomaly. Correspondingly, the firewall module may establish an anomaly handling list and continuously optimize a capability to handle anomalies through the anomaly handling list.

The firewall module deals with transmission anomalies, especially focusing on transmission anomalies that are critical to the operation of the system. The anomaly handling list is intended to cover anomalies of all the devices 120. However, some devices 120 may not have security risks, and the firewall module can ignore these anomalies. For example, some error events are caused by noise during the data transmission, and only denoising at the recipient is required.

According to the driver assistance system in the present disclosure, the firewall of the driver assistance system is embedded into a chip and is a chip-level firewall. The firewall embedded into the chip can be directly integrated with hardware of the driver assistance system to provide more stable and reliable security protection. The driver assistance system according to the present disclosure uses a chip-level firewall, has characteristics of real-time response, low latency, resistance to hardware-level attacks, and can actively defend against various malicious attacks, which, compared with traditional firewalls, processes data faster, allows a larger amount of data, and can provide a higher level of security protection and provide more reliable security protection for an on-board network environment of the driver assistance system.

According to the driver assistance system in the present disclosure, the chip system (SOC) uses a dual-core design: a security processor and an application processor. The security processor is mainly responsible for overall protection of safe operation of the system. The application processor is mainly responsible for specific functional application software, operation of program middleware, and big data calculation and processing. In this way, safety protection and functional application of the driver assistance system are separated from each other, which can prevent influences of functional application programs and execution processes of the application processor on a security protection program of the security processor.

The driver assistance system according to the present disclosure includes a plurality of startup stages. In each startup stage, the component started in a current stage is required to be detected, and parameters of the component started in a previous startup stage are also required to be automatically checked, to ensure integrity of running software.

In the driver assistance system according to the present disclosure, communication data is encrypted to prevent cracking of and tampering with the transmitted data. At the same time, during transmission, the data chain can be monitored in real time to respond to anomalies that occur when the data chain passes through the firewall in a timely manner, ensuring data security and reliability.

In another aspect of the present disclosure, a vehicle is provided. The vehicle is equipped with the driver assistance system according to the above embodiments.

It should be understood that the driver assistance system according to the present disclosure is applicable to vehicles, and is also applicable to ships, aircrafts, aerocrafts, and the like.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

What is claimed is:

1. A driver assistance system, comprising:
a plurality of devices configured to transmit data or signals; and
a chip system comprising a security processor, the security processor being configured to run a firewall program to build a firewall module embedded into the chip system, and the firewall module intercepting the data or signals transmitted by the plurality of devices according to a predetermined rule.

2. The driver assistance system according to claim 1, wherein the chip system further comprises an application processor, the application processor being started after the firewall module is built, and being configured to run an application program of the driver assistance system to cause the plurality of devices to transmit the data or signals.

3. The driver assistance system according to claim 2, further comprising a plurality of memory areas respectively used by the plurality of devices when transmitting the data;
wherein the security processor is configured to enable or disable access of the application processor to part of the plurality of memory areas of the driver assistance system.

4. The driver assistance system according to claim 1, wherein the security processor comprises a plurality of security control registers respectively configured to set firewall modules with different predetermined rules for different devices, the plurality of security control registers being accessible only by the security processor.

5. The driver assistance system according to claim 1, wherein the security processor is integrated with a one time programmable (OTP) memory, the OTP memory storing configuration information of the firewall module in an unmodifiable manner and being accessible only by the security processor.

6. The driver assistance system according to claim 1, wherein startup of the driver assistance system comprises a plurality of startup stages, a respective component being started in each of the plurality of startup stages;
in each of the plurality of startup stages, the driver assistance system verifies correctness of operation of a component started in a current startup stage and verifies correctness of operation of a component started in a previous startup stage; and
in response to determining that both the correctness of operation of the component started in the current startup stage and the correctness of operation of the component started in the previous startup stage pass the verification, a next startup stage is entered until the startup of the driver assistance system is completed.

7. The driver assistance system according to claim 1, wherein the firewall module is further configured to:
detect whether a data transmission request signal from one of the plurality of devices is legal;
allow, in response to determining that the data transmission request signal is legal, the one of the plurality of devices to send data corresponding to the data transmission request signal; and
record, in response to determining that the data transmission request signal is illegal, that the one of the plurality of devices has a transmission anomaly, thereby obtaining a device that is recorded as having the transmission anomaly.

8. The driver assistance system according to claim 7, wherein the firewall module is further configured to:
detect data transmission request signals from different devices in the plurality of devices according to predetermined priorities.

9. The driver assistance system according to claim 7, wherein the firewall module is further configured to:
encrypt the data sent by the one of the plurality of devices and package the data into a secure data chain in a specific format for transmission; and
transmit the secure data chain to an intended recipient in response to determining that the transmitted data is a secure data chain that conforms to the specific format, and
intercept the transmitted data and record that the one of the plurality of devices has the transmission anomaly in response to determining that the transmitted data is not a secure data chain that conforms to the specific format.

10. The driver assistance system according to claim 9, wherein the firewall module is further configured to:
decrypt the secure data chain to calculate a decryption value when the intended recipient receives the secure data chain; and
verify whether the decryption value is abnormal, and record that the one of the plurality of devices has the transmission anomaly in response to determining that the decryption value is abnormal.

11. The driver assistance system according to claim 8, wherein the firewall module is further configured to:
reduce a priority of the device that is recorded as having the transmission anomaly or set a communication permission thereof to permanently disabled.

12. The driver assistance system according to claim 1, further comprising a buffer memory area;
wherein data is transmitted to one of the plurality of devices that is capable of directly exchanging data with the outside of the driver assistance system, data to be transmitted is stored in the buffer memory area through a data transmission channel, and the one of the plurality of devices that is capable of directly exchanging data with the outside of the driver assistance system reads the data by accessing the buffer memory area; and
an access permission of the one of the plurality of devices that is capable of directly exchanging data with the outside of the driver assistance system to the buffer memory area is limited to reading data without modification, and the access permission is only opened after the data transmission channel is disconnected.

13. The driver assistance system according to claim 8, wherein the firewall module is further configured to send a diagnostic signal to the plurality of devices, and determine states of the plurality of devices according to a response signal sent by the plurality of devices to the firewall module in response to receiving the diagnostic signal; and
the diagnostic signal is sent to the device that is recorded as having the transmission anomaly in the plurality of devices more frequently than to the remaining devices of the plurality of devices.

14. The driver assistance system according to claim 7, wherein the firewall module is further configured to judge, according to the data transmission request signal from the one of the plurality of devices, whether the one of the plurality of devices is a device capable of directly exchanging data with the outside of the driver assistance system; and
set a dedicated data communication network for the one of the plurality of devices in response to determining that the judgment is yes.

15. The driver assistance system according to claim 1, wherein the firewall module is further configured to record and analyze a running log of the driver assistance system during transmission of the data or signals.

16. A vehicle, equipped with a driver assistance system according to claim 1, wherein the driver assistance system comprises:
a plurality of devices configured to transmit data or signals; and
a chip system comprising a security processor, the security processor being configured to run a firewall program to build a firewall module embedded into the chip system, and the firewall module intercepting the data or signals transmitted by the plurality of devices according to a predetermined rule.
